(19) United States
(12) Patent Application Publication
(10) Pub. No.: US 2004/0202433 A1
(43) Pub. Date: Oct. 14, 2004

(54) Ferrule flexure assembly for optical modules

(76) Inventor: Rickie C. Lake, Sunnyvale, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/412,083

(22) Filed: Apr. 10, 2003

(51) Int. Cl. G02B 6/26; G02B 6/42

(52) U.S. Cl. 385/90; 385/78

(57) ABSTRACT

The polarization extinction ratio (PER) for a polarizing maintaining fiber is kept at an acceptable level by attaching the fiber to a ferrule which is in turn attached to a flexure for precision alignment in an optical package. The ferrule may be attached to the top of the flexure or to the underside of the flexure if height space is a consideration. The ferrule aids in maintaining the optical properties of the fiber which may otherwise be unacceptably altered if the ferrule were not present.

### FIELD OF THE INVENTION

An embodiment of the present invention relates to optical packaging and, more particularly, to methods and apparatuses for facilitating precision alignment between various optoelectronic components.

### BACKGROUND INFORMATION

Wavelength division multiplexing (WDM) is a technique used to transmit multiple channels of data simultaneously over the same optic fiber. At a transmitter end, different data channels are modulated using light having different wavelengths or, colors if you will, for each channel. The fiber can simultaneously carry multiple channels in this manner. At a receiving end, these multiplexed channels are easily separated prior to demodulation using appropriate wavelength filtering techniques.

The need to transmit greater amounts of data over a fiber has led to so-called Dense Wavelength Division Multiplexing (DWDM). DWDM involves packing additional channels into a given bandwidth space. The resultant narrower spacing between adjacent channels in DWDM systems demands precision wavelength accuracy from the transmitting laser diodes. Further, DWDM systems require tight mechanical tolerances and precision coupling between various components.

One of the major challenges in the optoelectronic assembly process is to couple light from one chip to another. Particularly challenging may be coupling the fiber to the module while maintaining tight tolerances. In brief, the alignment process can generally be summarized in just a couple of steps.

First, two components are aligned. Tight tolerances are required. For example, tolerances of less than 50 nm of precision are not uncommon between the components. Second, the components must be bonded or otherwise secured to a surface while being careful to keep the alignment.

Finally, the assembly needs to be reliable. That is, the finished assembly including the bonding must be stable under temperature cycling, aging, shock, vibration, and any other condition that the assembly may reasonably be expected to encounter. It is very difficult to hold the alignment while making the bond. Often some shift or movement occurs between the components which, if greater than the minimum tolerances dictate, may render the component unworkable or at least seriously degrade performance.

### BRIEF DESCRIPTION OF THE DRAWINGS

The following is a brief description of the drawings, wherein like numerals indicate like elements throughout:

FIG. 1 is a plan view of a wavelength locker according to one embodiment of the invention;

FIG. 2 is a plan view of a flexure having a fiber attached directly thereto;

FIGS. 3A-B is a plan view and a top view of a flexure having a fiber-ferrule assembly attached to a top side, respectively; and

FIG. 4 is a plan view of a flexure having a fiber-ferrule assembly attached to the flexure's underside.

### DETAILED DESCRIPTION

Precision alignment between the fiber and an optoelectrical module is important to device performance. One optical packaging assembly approach involves soldering a fiber directly onto a flexure and then aligning the fiber-flexure assembly to the laser diode and welding the flexure feet in place. This method requires that a metallized fiber be directly soldered to a solderable flexure. This method works acceptably for Single Mode (SMF) fibers. However, in the case of Polarization Maintaining (PM) fibers, directly soldering the fiber to the flexure may cause an unacceptable disturbance to the optical properties of the fiber due to the stresses applied to the fiber by the solder. One such disturbance may be a substantial drop in the polarization extinction ratio (PER).

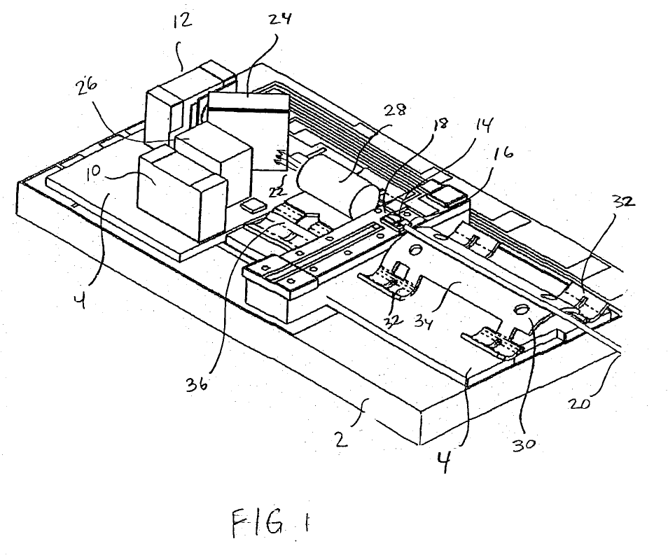

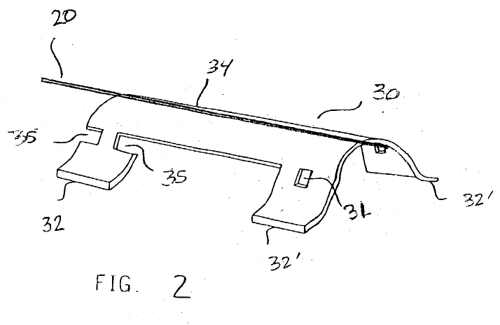

As an example of an application where a fiber is aligned to an opto-electric module is shown in FIG. 1 in the form of a wavelength locker package. Of course this is by way of example only and not meant to limit the types of packages in which embodiments of the invention may be practiced. As shown a wavelength locker package comprises a quasi-planar substrate 2 having a positioning floor 4. First and second detectors, 10 and 12, respectively, are attached to the floor 4. A laser 14, produces a laser beam centered about a set frequency or wavelength. The laser 14 emits a light beam from both a front facet 16 and a back facet 18. The actual modulated light carrying the data channel emerges from the front facet 16, which is coupled to an optical fiber 20. The beam 22 that emerges from the back facet 18 and is used for monitoring purposes. A lens 28, such as a graded index (GRIN) lens, is used to collimate the beam 22.

In operation a collimated beam 22 emerges from lens 28 and thereafter encounters a splitter 24 that splits the beam 22 into two additional beams. The first beam is shown reflected at an angle normal to the original beam 22. This reflected beam passes through an etalon (filter) 26 and then falls on the first detector 10. The second beam passes straight through the splitter 24 and falls upon the second detector 12. The portion of the beam that traverses the etalon 26 is a function of both the beam's power and the wavelength of the beam. The portion of the beam that passes directly from the splitter 24 to the second detector 12 is a function of the beam's power. Thus, by mathematically manipulating these two components the wavelength of the beam currently being output can be determined and compared to the set frequency to determine and correct any drift of the laser's output.

Components such as those described above, require precise alignment and present many challenges during manufacture when actually attaching the various devices. Attaching the fiber 20 may cause particular challenges. In high performance opto-electronic packages, such as these, critical optical elements require more precise placement than can be obtained with the combination of floor height control and two-dimensional pick and place.

Thus as shown, the fiber 20 is mounted using a miniature flexure 30 which allows for a small amount of vertical adjustment. In one embodiment, the flexure 30 is made of thin spring steel that has been etched or stamped, then bent in a press. The flexure 30 may comprise two or more legs 32 which rest on the substrate surface or positioning floor 4. In one embodiment, the legs are joined by a bridge 34 that supports or clamps the fiber 20. When the bridge 34 is translated in the y direction, legs 32 give elastically in opposite x directions.

The flexure 30 may be designed so that in its natural or non-flexed state, the optical axis of the optical component attached to the bridge 34 rests slightly above the optical plane of the package. Final adjustment of the height is obtained by applying pressure to the flexure 30, thereby lowering the bridge 34 height. Dragging the flexure 30 in the plane parallel to the plane of the substrate may be used to correct the lateral position.

The first pair of legs 32 or 32′ is attached to the frame after coarse optical alignment. The flexure 30 is then finely re-aligned, using the residual flexibility left after the two first legs are attached. When the optimum position is reached, the remaining legs 32 or 32′ are attached. Attachment may be by, for example, laser welding, soldering, or adhesive bonding. Various flexure designs are described in U.S. Pat. Nos. 6,207,950 and 6,227,724. As shown, the flexure has two pair of legs 32 and 32′. However, for larger or smaller applications refinements of the flexure design may include more than two pair or only a single pair of legs 32.

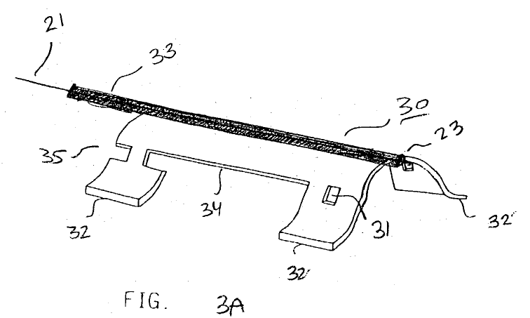

Referring now to FIG. 2, there is show an embodiment of the flexure 30 comprising a front pair of legs 32 and a rear pair of legs 32′ connected by a bridge 34. As previously noted, the flexure 30 may be made of thin spring metal such as steel or another material with similar properties that has been etched or stamped, then bent in a press. The legs may include apertures 31, as shown in front legs 32, or notches 35 as shown in rear legs 32′ to enhance flexibility. A fiber 20 may be soldered directly onto the flexure 30 and, as described above, the fiber-flexure assembly may be aligned to a laser diode device by welding the flexure legs 32 and 32′ in place. In this case, a metallized fiber 20 is directly soldered to a solderable flexure 30.

While this method works well for Single Mode (SM) fibers, it may not be preferred if the fiber 20 is a Polarization Maintaining (PM) fiber since direct soldering may create stresses and disturb the optical properties of the fiber. This may lead to a significant drop in the polarization extinction ratio (PER). One solution to this problem for PM fibers is to attach and fix a fiber into a cylindrical ferrule using either metallic solder, glass or epoxy, such that the stresses are symmetrical around the circumference of the fiber. Thereafter, the ferruled fiber may be inserted into a feedthrough of an enclosure for alignment and then the ferrule fixed into place by solder sealing the ferrule to the feedthrough. Although this method helps to address the stresses applied to the fiber and it's affect on the optical properties of the fiber, it does not lend itself to flexure assembly techniques. Further, when optical alignment is made and the ferrule is soldered to the package feedthrough, shrinkage and shift of the materials during cooling cause the extremely accurate alignments to be compromised and a rework may be required to return the alignment to it's desired point.

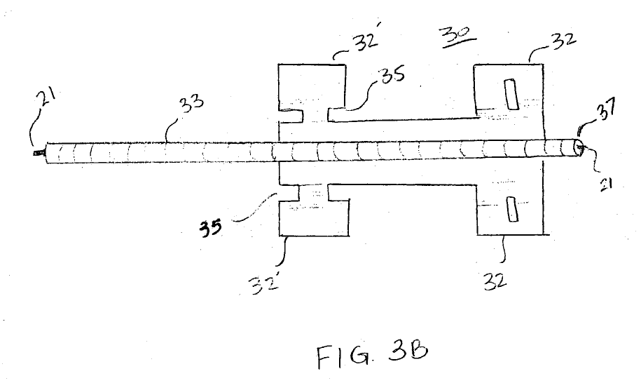

Referring to FIGS. 3A and 3B, there is shown a plan view and a top view, respectively, of a fiber on flexure assembly according to one embodiment of the invention. As shown, a fiber 21 such as a polarization maintaining (PM) fiber is first attached to a ferrule 33. As shown, the fiber 20 extends through the length of the ferrule 33. The fiber 21 is attached to a ferrule 33 which is in turn attached to a flexure 30. As herein illustrated the ferrule 33 may be at least as long and the length of the flexure 30 with the input end 37 of the fiber extending only slightly beyond the flexure 30. However, the ferrule 33 may be shorter than, equal to, or longer than the flexure 30.

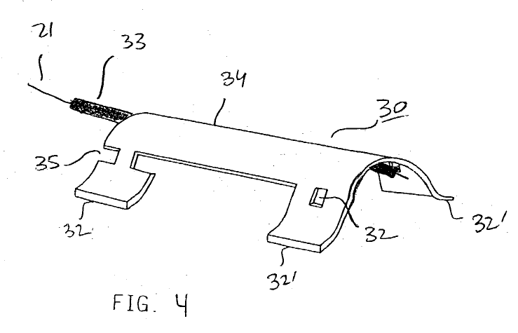

The sequence of assembly may be manipulated several different ways depending on the desired results. For example, a fiber 21 can be fixed to the ferrule 33, the fiber-ferrule unit can then be attached to the flexure 30. Another approach may be to attach the ferrule 33 to the flexure 30 first, then attach the fiber 21 into the ferrule 33. The fiber 21 may be attached to the ferrule 33, for example using metallic solders, epoxies, or solder glass. The ferrule 33 may be attached to the flexure, for example, using metallic solders, welding (e.g., resistance or laser) or even epoxies. The ferrule 33 can be mounted to the topside of the flexure 30 or alternatively, on the underside of the flexure as shown in FIG. 4, in order to minimize height.

The shape of the ferrule 30 as shown is cylindrical with a circular cross-section. However, because the ferrule 30 is not used to provide a seal in the feedthrough of an enclosure, the ferrule 30 can be made in any shape such as square, rectangular, triangular, octagonal, or any other desirable non-circular cross-sectional shape to facilitate attachment onto any flexure body configuration.

By placing the fiber 21 into a ferrule 33 and attaching it to a flexure 30, the polarization extinction ratio (PER) remains acceptable. By then combining the ferrule to a flexure as described assembly of, for example, tunable laser packages is facilitated. Also, by attaching the fiber 21 into the ferrule 33 first, the combined fiber-ferrule module can be tested prior to fixing it to the flexure 30. If other changes in the optical properties such as launch angle are realized, they can be addressed and accounted for when soldering the ferrule-fiber unit to the flexure 30 as there are no additional changes in the optical properties when soldering the ferrule-fiber unit to the flexure.

The above description of illustrated embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the claims. Rather, the scope of the invention is to be determined entirely by the following claims, which are to be construed in accordance with established doctrines of claim interpretation.

What is claimed is:

1. An optical device, comprising:
a flexure;
a ferrule;
a fiber traversing through said ferrule, said ferrule being attached to said flexure.

2. The optical device as recited in claim 1, wherein said flexure comprises:
at least one pair of flexible legs; and
a bridge portion supported by said legs.

3. The optical device as recited in claim 2, wherein said ferrule is attached to a top side of said bridge portion.

4. The optical device as recited in claim 2, wherein said ferrule is attached to an underside of said bridge portion.

5. The optical device as recited in claim 1, wherein said ferrule is generally cylindrical in shape having a circular cross-section.

6. The optical device as recited in claim 1, wherein said ferrule is generally cylindrical in shape having one of a square, rectangular, triangular, octagonal, or other non-circular cross-section.

7. The optical device as recited in claim 1, wherein said flexure comprises:
at least two pair of flexible legs; and
a bridge portion supported by said legs.

8. The optical device as recited in claim 1, wherein said ferrule is attached to said flexure by one of metallic solder, welding and epoxies.

9. The optical device as recited in claim 1, wherein said fiber is attached to said ferrule by one of metallic solder, epoxy, and solder glass.

10. The optical device as recited in claim 2, wherein said at least one pair of legs of said flexure is attached for alignment to a device having a laser diode.

11. A method of assembling and optical device, comprising:
a) providing a flexure having at least one pair of legs and a bridge portion supported by said legs;
b) attaching a fiber through a ferrule;
c) attaching said ferrule to one of a topside and underside of said bridge portion of said flexure.

12. The method as recited in claim 11, wherein (b) and (c) may be performed in either order.

13. The method as recited in claim 11, wherein said fiber comprises a polarization maintaining (PM) fiber.

14. The method as recited in claim 11, further comprising:
d) testing said fiber attached through said ferrule prior to attaching said ferrule to said bridge portion of said flexure.

15. The method as recited in claim 12, wherein said ferrule is attached to said flexure by one of metallic solder, welding and epoxies.

16. The method as recited in claim 12, said fiber is attached to said ferrule by one of metallic solder, epoxy, and solder glass.

17. An optical system, comprising:
a dense wavelength division multiplex (DWDM) package having a polarizing maintaining (PM) fiber to carry optical signals;
a flexure;
a ferrule,
said fiber traversing through said ferrule, said ferrule attached to said flexure inside said package.

18. The optical system as recited in claim 17, wherein said flexure comprises:
at least one pair of flexible legs; and
a bridge portion supported by said legs.

19. The optical system as recited in claim 18, wherein said ferrule is attached to a top side of said bridge portion.

20. The optical system as recited in claim 18, wherein said ferrule is attached to an underside of said bridge portion.

21. The optical system as recited in claim 17, wherein said ferrule is generally cylindrical in shape having a circular cross-section.

22. The optical system as recited in claim 17, wherein said ferrule is generally cylindrical in shape having one of a square, rectangular, triangular, octagonal, or other non-circular cross-section.

23. The optical system as recited in claim 17, wherein said flexure comprises:
at least two pair of flexible legs; and
a bridge portion supported by said legs.
